(19) United States
(12) Patent Application Publication
(10) Pub. No.: US 2025/0201840 A1
(43) Pub. Date: Jun. 19, 2025

(54) NEGATIVE ELECTRODE MIXTURE LAYER AND LIQUID-BASED BATTERY

(71) Applicant: TOYOTA JIDOSHA KABUSHIKI KAISHA, Toyota-shi (JP)

(72) Inventor: Masataka TOMITA, Nisshin-shi (JP)

(73) Assignee: TOYOTA JIDOSHA KABUSHIKI KAISHA, Toyota-shi (JP)

(21) Appl. No.: 18/960,355

(22) Filed: Nov. 26, 2024

(30) Foreign Application Priority Data
Dec. 18, 2023 (JP) 2023-213378

(51) Int. Cl. H01M 4/583; H01M 4/02; H01M 4/131; H01M 4/133; H01M 4/525; H01M 4/62

(52) U.S. Cl. CPC H01M 4/583; H01M 4/131; H01M 4/133; H01M 4/525; H01M 4/623; H01M 4/625; H01M 2004/027; H01M 2004/028

(57) ABSTRACT

The present disclosure relates to a negative electrode mixture layer and a liquid-based battery. The negative electrode mixture layer used in the liquid-based battery having an electrolytic solution contains a negative electrode active material and polyvinylidene fluoride having a crystallinity of 43% or more and 93% or less. The negative electrode mixture layer has an average thickness of 150 μm or more.

### CROSS-REFERENCE TO RELATED APPLICATION

This application claims priority to Japanese Patent Application No. 2023-213378 filed on Dec. 18, 2023, incorporated herein by reference in its entirety.

### BACKGROUND

### 1. Technical Field

The present disclosure relates to a negative electrode mixture layer and a liquid-based battery.

### 2. Description of Related Art

A negative electrode mixture layer containing various binders has conventionally been studied as a negative electrode mixture layer to be used in a battery.

For example, Japanese Unexamined Patent Application Publication No. 2020-115441 (JP 2020-115441 A) discloses the following electrode. A battery includes at least an active material and a binder. The binder contains polyvinylidene fluoride. In the FT-IR spectrum of the binder, the intensity ratio (A/B) between a peak A near 1210 cm⁻¹ and a peak B near 1275 cm⁻¹ is 3.60 or more and 5.92 or less. The thickness of the electrode is 205 μm or more and 994 μm or less.

Japanese Unexamined Patent Application Publication No. 2009-087885 (JP 2009-087885 A) discloses a method of manufacturing a positive electrode. This manufacturing method includes preparing positive electrode mixture slurry by mixing phosphorous acid (H₃PO₃) with a positive electrode active material, and applying the positive electrode mixture slurry to a positive electrode current collector to form a positive electrode active material layer.

Japanese Unexamined Patent Application Publication No. 2012-150972 (JP 2012-150972 A) discloses a lithium ion battery including a positive electrode capable of occluding and releasing lithium ions, a negative electrode capable of occluding and releasing lithium ions, a separator disposed between the positive electrode and the negative electrode, and an electrolytic solution. A binder of a negative electrode mixture layer contains polyvinylidene fluoride. The crystallinity degree of polyvinylidene fluoride in the negative electrode mixture layer is higher on the current collector side than on the separator side. The value of R₁ calculated by (formula 1: R₁=A763/A840) from an absorbance (A736) at 736 cm⁻¹ and an absorbance (A840) at 840 cm⁻¹ obtained through IR measurement is more than 1.5 on the current collector side, and is equal to or less than 1.5 on the separator side.

### SUMMARY

In conventional liquid-based batteries, a negative electrode mixture layer in which styrene-butadiene rubber (SBR) is used as a binder, for example, is used. When SBR is used as a binder, however, aggregation occurs and ion diffusion hardly occurs, and ion conductivity may be poor after repeated charging and discharging.

The present disclosure has been made in view of the above circumstances, and an object of the present disclosure is to provide a negative electrode mixture layer capable of providing a liquid-based battery including the negative electrode mixture layer with high ion conductivity, and a liquid-based battery including the negative electrode mixture layer.

Means for addressing the above issue include the following aspects.

<1> A negative electrode mixture layer to be used in a liquid-based battery including an electrolytic solution, including:
a negative electrode active material; and
polyvinylidene fluoride with a crystallinity degree of 43% or more and 93% or less, in which an average thickness of the negative electrode mixture layer is 150 μm or more.

<2> In the negative electrode mixture layer according to <1>, a content of the polyvinylidene fluoride with respect to the negative electrode active material may be 0.11% by mass or less.

<3> In the negative electrode mixture layer according to <1> or <2>, the average thickness of the negative electrode mixture layer may be 150 μm or more and 355 μm or less.

<4> A liquid-based battery including:
a current collector foil;
a positive electrode mixture layer and the negative electrode mixture layer according to any one of <1> to <3> disposed on the current collector foil; and
an electrolytic solution.

According to the present disclosure, it is possible to provide a negative electrode mixture layer capable of providing a liquid-based battery including the negative electrode mixture layer with high ion conductivity, and a liquid-based battery including the negative electrode mixture layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an equivalent circuit used in calculating the degree of flexion in an embodiment;

FIG. 2 is a graph showing a change in the degree of bending of the electrode with respect to the thickness of the negative electrode as confirmed in the embodiment; and

FIG. 3 is a graph showing the change in the discharging rate with respect to the content of PVDF in the negative electrode mixture layer, as confirmed in the embodiment.

### DETAILED DESCRIPTION OF EMBODIMENTS

Hereinafter, an embodiment which is an example of the present disclosure will be described. These descriptions and examples are illustrative of the embodiments and are not intended to limit the scope of the disclosure.

In the numerical ranges described in the present specification in a stepwise manner, the upper limit value or the lower limit value described in one numerical range may be replaced with the upper limit value or the lower limit value of the numerical range described in another stepwise manner. In addition, in the numerical range described in the present specification, the upper limit value or the lower limit value of the numerical range may be replaced with the value shown in the examples.

Each component may contain a plurality of corresponding substances. When referring to the amount of each component in a composition, when a plurality of substances corresponding to each component are present in the composition, unless otherwise specified, the total amount of the plurality of substances present in the composition is meant.

### Negative Electrode Mixture Layer

The negative electrode mixture layer according to the embodiment of the present disclosure is a negative electrode mixture layer used in a liquid-based battery having an electrolytic solution. The negative electrode mixture layers contain a negative electrode active material and polyvinylidene fluoride (Polyvinylidene fluoride, hereinafter also simply referred to as “PVDF”) having a crystallinity degree of 43% or more and 93% or less. The thickness of the negative electrode mixture layer is 150 μm or more.

The thickness of the negative electrode mixture layer means the average thickness of only the negative electrode mixture layer formed on one side of the current collector foil, that is, on one side of the current collector foil, in the case of the negative electrode mixture layer disposed on the current collector foil in the liquid-based battery.

When the negative electrode mixture layer according to the embodiment of the present disclosure satisfies the above-described configuration, a high ionic conductivity can be obtained in a liquid-based battery including the negative electrode mixture layer. The reason is inferred as follows.

In conventional liquid-based batteries, for example, negative electrode mixture layers using styrene-butadiene rubber (SBR) as a binder are used. However, when the negative electrode mixture layer is formed by coating and drying the negative electrode mixture in the form of a current collector foil, in SBR of a binder, migration phenomena occur in which the negative electrode mixture layer floats and aggregates on the front surface of the coating layer. When SBR is aggregated on or in the negative electrode mixture layers, ion diffusion is less likely to occur, and the ion conductivity after repeated charging and discharging may be inferior.

On the other hand, the negative electrode mixture layers according to the embodiments of the present disclosure include polyvinylidene fluoride (PVDF) having a crystallinity degree of 43% or more and 93% or less as a binder. Even in PVDF as the binder, migration occurs in a small amount in the same manner as in SBR, that is, it is considered that aggregation occurs on or inside the negative electrode mixture layers. However, PVDF has a property of swelling while keeping the electrolytic solution in the liquid-based battery, and the retained electrolytic solution exhibits ionic conductivity. Therefore, unlike when SBR aggregates are present in the negative electrode mixture layers, even if PVDF aggregates are present, they do not become blocked pores, and a decrease in ion-diffusivity is suppressed. In PVDF, in particular, since the amorphous portion has a property of retaining and swelling the electrolytic solution, the ratio of the amorphous portion of PVDF is critical for the development of the ionic conductivity. Therefore, by using a PVDF having a crystallinity of 43% or more and 93% or less, that is, a large proportion of the amorphous part, the electrolytic solution is appropriately retained in the binder.

As a result, high ionic conductivity can be obtained in the liquid-based battery including the negative electrode mixture layer.

### Crystallinity of PVDF

In the negative electrode mixture layers, PVDF contained as a binder has a crystallinity of 43% or more and 93% or less. When the crystallinity is 93% or less, the ratio of the amorphous part becomes a large PVDF, and the electrolytic solution is appropriately held in the binder, resulting in high ionic conductivity in liquid-based batteries. When the crystallinity is 43% or more, high ionic conductivity can be obtained in a liquid-based battery.

The crystallinity of PVDF is preferably 50% or more and 85% or less, and more preferably 60% or more and 75% or less, from the viewpoint of obtaining higher ionic conductivity in a liquid-based battery.

The crystallinity of PVDF is measured by the following methods. After the electrode having no positive electrode mixture layer is vacuum-dried at 45° C., a part of the primer layer is scraped out by a razor, and NMR (nuclear magnetic resonance) of the powder is measured. The analysis method is as follows. After measuring NMR, determine the areas of the crystalline and amorphous peaks at the main peak of PVDF, and calculate the crystallinity by calculating the % of the area of the crystalline from the sum of these areas.

### Average Thickness of the Negative Electrode Mixture Layer

The average thickness of the negative electrode mixture layer is 150 μm or more. When the average thickness of the negative electrode mixture layer is 150 μm or more, the influence of the migration of the binder on the ion conductivity becomes large. However, in the case of the negative electrode mixture layers according to the embodiments of the present disclosure, the ratio of the amorphous part becomes a large PVDF, and the electrolytic solution is appropriately held in the binder. Therefore, a high ionic conductivity can be obtained in a liquid-based battery.

The average thickness of the negative electrode mixture layer is preferably 150 μm or more and 355 μm or less.

The average thickness means an arithmetic average value of 10 arbitrarily selected thicknesses.

### PVDF Content

The content of PVDF with respect to the negative electrode active material is preferably 0.11% by mass or less. When the content of PVDF is 0.11% by mass or less, the ionic conductivity of the liquid-based battery can be increased.

The content of PVDF with respect to the negative electrode active material is more preferably 0.09% by mass or less.

### Components of the Negative Electrode Mixture Layer

The negative electrode mixture layer includes a negative electrode active material. Examples of the negative electrode active material include metals such as metal lithium, metal indium, metal aluminum, metal silicon, and metal tin that can form an alloy with metal lithium or metal lithium, oxides of these metals, and alloys of these metals and metal lithium. Examples of the oxide include an oxide active material such as Li₄Ti₅O₁₂.

The negative electrode mixture layer includes a binder in addition to the negative electrode active material. Examples of the binder include, in addition to PVDF, rubbers such as styrene-butadiene copolymer (SBR).

The negative electrode active material layer may further contain other components such as a thickener. Examples of the thickener include celluloses such as carboxymethylcellulose (CMC).

### Battery

Next, each component constituting the liquid-based battery according to the embodiment of the present disclosure will be described.

### Positive Electrode Mixture Layer

The positive electrode mixture layer includes a positive electrode active material, and may further include, for example, a binder.

Examples of the positive electrode active material include a lithium nickel-cobalt-manganese complex oxide (hereinafter, sometimes simply referred to as “LNCM”). The simplest LNCM is represented by the following general formula: LiNiₓCo_{y}Mn_{z}O₂ (where x, y, z are 0<x<1, 0<y<1, 0<z<1, x+y+z=1). In addition to Li, Ni, Co, Mn, LNCM may contain other additive elements, such as transition-metal elements other than Ni, Co, Mn, and typical metal elements other than Li. LNCM has a layered crystalline architecture. LNCM may be more than 50% by mass of the entire positive electrode active material, for example, 80 to 100% by mass. The positive electrode active material may be composed only of LNCM.

Examples of other positive electrode active materials include a lithium nickel composite oxide, a lithium cobalt composite oxide, and a lithium nickel manganese composite oxide.

Examples of the binder included in the positive electrode mixture layers include vinyl halide resins such as polyvinylidene fluoride (PVdF).

The positive electrode mixture layer may further contain other components such as a conductive material. Examples of the conductive material include non-graphitizable carbon, graphitizable carbon such as carbon black, and graphite.

### Anode Active Layer

The above-described negative electrode mixture layer is used as the negative electrode active material layer. Details have already been described, and therefore will be omitted here.

### Cathode Current Collector

The positive electrode mixture layer is formed on the positive electrode current collector. As the positive electrode current collector, a conductive member made of a metal having good conductivity (for example, aluminum) is preferable.

### Anode Current Collector

The negative electrode mixture layer is formed on the negative electrode current collector. As the negative electrode current collector, a conductive member made of a metal having good conductivity (for example, copper) is preferable.

### Separator

The separator is an electrically insulating porous film. The separator electrically isolates the positive electrode and the negative electrode. The separator may have a thickness of, for example, 5 to 30 μm. The separators may be formed of, for example, a porous polyethylene (PE) membrane, a porous polypropylene (PP) membrane, or the like. The separator may have a multilayer structure. For example, the separators may be formed by laminating a porous PP membrane, a porous PE membrane, and a porous PP membrane in this order. The separator may have a heat resistant layer on its surface. The heat resistant layer includes a heat resistant material. Examples of the heat resistant material include metal oxide particles such as alumina, and high melting point resins such as polyimide.

### Electrolyte

A battery according to an embodiment of the present disclosure further includes an electrolyte. As the electrolyte, either a solid electrolyte or an electrolytic solution can be employed. Here, an electrolyte will be described by taking an electrolytic solution as an example. In particular, a non-aqueous electrolytic solution is preferable.

### Solvent

The non-aqueous electrolytic solution includes a solvent (non-aqueous solvent) and an electrolyte.

Examples of the solvent (non-aqueous solvent) include N,N-diethyl-N-methyl-N-(2-methoxyethyl) ammonium bis(fluorosulfonyl)imide (DEME), 1-ethyl-3-methylimidazolium bis(fluorosulfonyl)imide (EMI), and 1-ethyl-2,3-dimethylimidazolium bis(fluorosulfonyl)imide (DEMI-FSI).

### Electrolyte

Examples of the electrolyte in the electrolytic solution include Li. Examples of Li salt include lithium bis(fluorosulfonyl)imide (LiFSI), LiPF₆ (lithium hexafluoride phosphate), lithium tetrafluoroborate (LiBF₄), Li[N(CF₃SO₂)]₂].

The quantity of electrolyte may be, for example, 1.0 to 2.0 mol/L, preferably 1.0 to 1.5 mol/L.

The electrolytic solution may contain, in addition to the solvent and the electrolyte, various additives such as a thickener, a film forming agent, a gas generating agent, and the like. The electrolyte is typically a liquid non-aqueous electrolytic solution at room temperature (e.g., 25±10° C.). The electrolytic solution typically exhibits a liquid state in the use environment of the battery (for example, in a temperature environment of −20° C. to +60° C.).

### Use

Applications of batteries according to the disclosed embodiments include, for example, power supplies such as hybrid electric vehicle (HEV), plug-in hybrid electric vehicle (PHEV), battery electric vehicle (BEV).

Hereinafter, the present disclosure will be described based on Examples, but the present disclosure is not limited to these Examples in any way.

### Prototype Electrode

In forming the positive electrode, a slurry was prepared in a ratio of [active material] LiNi_{0.8}Co_{0.1}Mn_{0.1}O₂: [conductive agent] single-walled carbon nanotube (MWCNT): [binder] PVDF=97.8:0.7:1.4 (units: wt %). The slurry was applied to a 30 μm Al foil (current collector) by a doctor blade, dried at 100° C. for 30 minutes, and pressed by a roll press so that the electrode density became 3.2 g/cc to form a positive electrode mixture layer.

In forming the negative electrode, a slurry was prepared in a ratio of [active material] artificial graphite: [binder] CMC: [binder] PVDF=97:0.6:2.4 (units: wt %). The slurry was applied to a 12 μm Cu foil (current collector) by a doctor blade, dried at 100° C. for 30 minutes, and pressed by a roll press so that the electrode density became 1.3 g/cc to form a negative electrode mixture layer. The basis weight of the negative electrode was adjusted so that the charge capacity of the negative electrode/the charge capacity of the positive electrode=1.1. Thereafter, a positive electrode/separator (three-layer structure of PP/PE/PP, mean thickness: 16 μm)/negative electrode was stacked to prepare a laminated cell. As the separator, a separator having a three-layer structure (mean thickness: 16 μm) of porous polypropylene (PP)/porous polyethylene (PE)/PP was used.

The electrolytic solution includes an electrolyte and an electrolyte salt. As the electrolyte, an electrolyte containing ethylene carbonate (EC), dimethyl carbonate (DMC), and ethyl methyl carbonate (EMC) in a ratio of EC:DMC:EMC=30:40:30 (by volume) was used. LiPF₆ 1.1 M (mol/l) was used as the electrolyte salt.

The crystallinity of PVDF was measured by the above-described methods.

### Activation and Characterization

The first charging current of the obtained electrode was a constant current-constant voltage method, and constant current charging was performed up to 4.25 V at 0.1 C current values. Thereafter, the electrode was charged with constant voltage until the time of constant voltage charging reached 3 hours. Then, 0.1 C current was discharged to 2.5 V by a constant current method. Thus, the battery was activated.

### Evaluation of Discharge Characteristics

The charging and discharging of the electrodes were performed by a constant current method, and the current rates were set to 0.1 C or 1.0 C.

$$1 C discharge rate = 0.1 CC discharge capacity / 1. C - CC discharge capacity \times 100 \% was calculated .$$

### Method of Calculating the Degree of Flexion

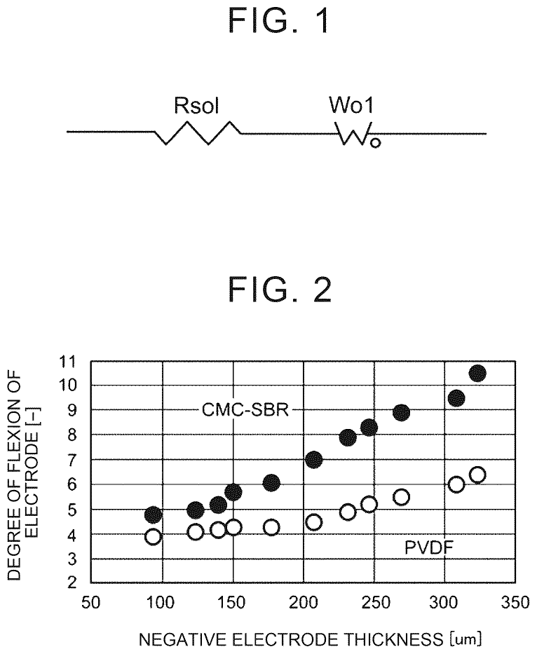

A symmetric laminated cell of negative electrode/separator/negative electrode was produced experimentally, and the degree of flexure was obtained. The electrolytic solution was impregnated for 12 hours, and then the AC imp. was measured at 25° C. The measured frequency was from 10 mHz to 1000000 Hz. From the equivalent circuit shown in FIG. 1, the ionic resistance [Ω] (resistance of W₀1 of the equivalent circuit) of the respective electrodes was calculated, and the degree of flexion was obtained from the following equation.

$$Flexibility τ = ( {R}_{i o n} \times A \times κ \times ε ) / 2 d$$

Where Rᵢₒₙ: ion resistance, A: electrode area, κ: ion conductivity, ε porosity, d: film thickness.

### Example 1

In the above-mentioned [trial manufacture of electrodes], an electrode in which PVDF as a binder was changed to SBR (2.4 mass %), and an electrode in which the quantity of PVDF was changed to 3.5 mass % were prepared. Then, the degree of bending when the average thickness (negative electrode thickness) of the negative electrode mixture layer was changed was measured. A graph of the results is shown in FIG. 2.

Flexibility is a kind of parameter representing ion diffusion in an electrode. The lower the degree of bending, the easier the ion diffusion in the electrode. Theoretically, even if the thickness is increased, the degree of bending is constant as long as the composition in the negative electrode mixture layer does not change. However, as shown in FIG. 2, the degree of bending tends to increase as the thickness of the negative electrode increases, and therefore, it can be seen that the influence of migration increases. Both the electrode using SBR as the binder and the electrode using PVDF tend to have an increased degree of bending as the thickness of the negative electrode increases, but the electrode using PVDF is less sensitive. Even when PVDF is used as the binder, migration phenomena and aggregation occur, but unlike when SBR is used, the binder itself has an ionically conductive function, and therefore, it is presumed that the binder is insensitive. Since the ionic conductivity by this PVDF is expressed by swelling of PVDF in the electrolytic solution, the crystallinity of PVDF, which is correlated with the swelling property, is considered to be critical.

### Example 2

Next, the difference in the degree of bending due to the difference in the crystallinity of PVDF was confirmed. In the above-described [trial manufacture of electrodes], electrodes were prepared using PVDF having differing crystallinity as binders. The negative electrode thickness was 177 μm. The results are shown in Table 1.

When the crystallinity of PVDF is 100%, the electrolytic solution cannot be maintained, and if PVDF binders migrate and aggregate, it is expected that ions will not pass in the vicinity thereof, and it is presumed that the degree of bending is deteriorated.

In addition, when the crystallinity is significantly low, that is, when the crystallinity is 37% or less, the degree of swelling of the binder becomes excessively high, and it is expected that the contact between the active materials is reduced or the voids are reduced, and it is presumed that the degree of bending is lowered.

When the crystallinity of PVDF as the binder is within the above-described range, a higher discharging rate can be exhibited even in the case of the thick film as compared with the case of using the conventional SBR binder.

TABLE 1

| | PVDF crystallinity degree | |
|---|---|---|
| Level | [%] | Bending degree |
| 1 | 100 | 6.0 |
| 2 | 91 | 4.4 |
| 3 | 72 | 4.2 |
| 4 | 63 | 4.3 |
| 5 | 45 | 4.5 |
| 6 | 37 | 5.6 |
| 7 | 24 | 6.2 |

### Example 3

Then, when SBR was used as the binder and when PVDF was used, the difference in discharging rate due to the difference in negative electrode thickness was confirmed. The crystallinity of PVDF was set to 63%.

When the negative electrode thickness is less than 150 μm, there is no difference in the discharging rate when SBR is used as the binder and when PVDF is used as the binder. On the other hand, when the negative electrode thickness is 150 μm or more, the discharge rate is significantly reduced when SBR is used, whereas the discharge rate is gently reduced when PVDF is used.

TABLE 2

| | Thickness of negative | SBR 1 C | PVDF 1 C |
|---|---|---|---|
| Level | electrode layer [μm] | rate [%] | rate [%] |
| 1 | 93 | 94 | 94 |
| 2 | 123 | 93 | 93 |
| 3 | 139 | 90 | 90 |
| 4 | 150 | 74 | 86 |
| 5 | 177 | 58 | 81 |
| 6 | 207 | 43 | 75 |
| 7 | 231 | 29 | 58 |
| 8 | 246 | 21 | 47 |
| 9 | 269 | 15 | 36 |
| 10 | 308 | 10 | 28 |
| 11 | 323 | 7 | 9 |

### Example 4

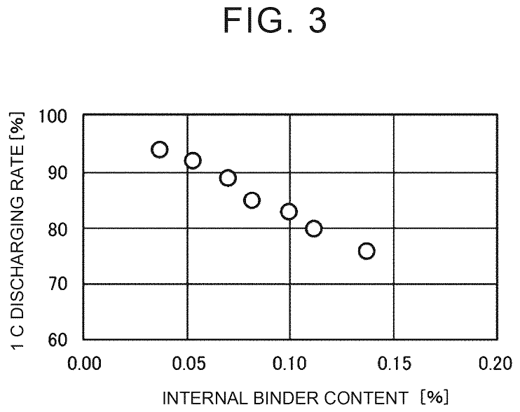

Next, differences in discharging rates were confirmed when the negative electrode thickness was 177 micrometers and the content ratio of PVDF (crystallinity: 63%) in the negative electrode mixture layers was changed. FIG. 3 shows the results.

1 C discharging rate tends to decrease as PVDF ratio in the negative electrode mixture layer (the binder content in the mixture) increases. It can be seen that the ratio of PVDF binders in the mixture is desirably 0.11% or less.

What is claimed is:

1. A negative electrode mixture layer to be used in a liquid-based battery including an electrolytic solution, the negative electrode mixture layer comprising:
a negative electrode active material; and
polyvinylidene fluoride with a crystallinity degree of 43% or more and 93% or less, wherein an average thickness of the negative electrode mixture layer is 150 μm or more.

2. The negative electrode mixture layer according to claim 1, wherein a content of the polyvinylidene fluoride with respect to the negative electrode active material is 0.11% by mass or less.

3. The negative electrode mixture layer according to claim 1, wherein the average thickness of the negative electrode mixture layer is 150 μm or more and 355 μm or less.

4. A liquid-based battery comprising:
a current collector foil;
a positive electrode mixture layer and the negative electrode mixture layer according to claim 1 disposed on the current collector foil; and
an electrolytic solution.
